(19) United States
(12) Patent Application Publication
(10) Pub. No.: US 2019/0344574 A1
(43) Pub. Date: Nov. 14, 2019

(54) INK CONTAINER AND INK-JET RECORDING APPARATUS INCLUDING SAME

(71) Applicant: KYOCERA Document Solutions Inc., Osaka (JP)

(72) Inventor: Masanobu MAESHIMA, Osaka (JP)

(21) Appl. No.: 16/409,966

(22) Filed: May 13, 2019

(30) Foreign Application Priority Data
May 14, 2018 (JP) 2018-093190

(51) Int. Cl. B41J 2/175

(52) U.S. Cl. CPC B41J 2/17513; B41J 2/1752; B41J 2/17553

(57) ABSTRACT

An ink container includes: an ink pack; and a housing case that houses the ink pack. The ink pack includes: a pack main body filled with ink; a spout attached to the pack main body and including a male screw part on an outer surface thereof; a cap having, on an inner surface thereof, a female screw part to be engaged with the male screw part; and a rotation restricting mechanism. The rotation restricting mechanism restricts rotation of the cap relative to the spout in a second rotation direction opposite to the first rotation direction during attachment, in a state where the female screw part is engaged with the male screw part and the cap is attached to the spout.

### INCORPORATION BY REFERENCE

This application is based upon, and claims the benefit of priority from, corresponding Japanese Patent Application No. 2018-093190 filed in the Japan Patent Office on May 14, 2018, the entire contents of which are incorporated herein by reference.

### BACKGROUND

### Field of the Invention

The present disclosure relates to an ink container and an ink-jet recording apparatus including the same.

### Description of Related Art

An ink-jet recording apparatus that forms images by ejecting ink is known as an image forming apparatus such as a printer. The ink-jet recording apparatus uses an ink container including a flexible ink pack filled with ink and a housing case for housing the ink pack in order to supply the ink to a recording unit that records images on a sheet.

### SUMMARY

An ink container according to one aspect of the present disclosure is an ink container in an ink-jet recording apparatus including a recording unit that records an image on a sheet by using ink, the ink container being attachable to an apparatus main body in which the recording unit is disposed. The ink container includes: an ink pack containing the ink to be supplied to the recording unit; and a housing case that houses the ink pack and is detachably attached to the apparatus main body. The ink pack includes: a pack main body filled with the ink; a tubular spout that is attached to an end of the pack main body, forms a first ink flow path communicating with inside of the pack main body, and includes a male screw part on an outer surface thereof; a cap having, on an inner surface thereof, a female screw part to be engaged with the male screw part by rotation of the cap relative to the spout in a first rotation direction; and a rotation restricting mechanism that restricts rotation of the cap relative to the spout in a second rotation direction opposite to the first rotation direction in a state where the female screw part is engaged with the male screw part and the cap is attached to the spout.

An ink-jet recording apparatus according to another aspect of the present disclosure includes an apparatus main body in which a recording unit for recording an image on a sheet by using ink is disposed; and the above-described ink container detachably attached to the apparatus main body and containing the ink to be supplied to the recording unit.

### BRIEF DESCRIPTION OF THE DRAWINGS

FIG. 1 is a diagram schematically showing an ink-jet recording apparatus according to an embodiment of the present disclosure;

FIG. 2 is an enlarged view showing the periphery of a recording unit of the ink-jet recording apparatus;

FIG. 3 is a perspective view of an ink container applied to the ink-jet recording apparatus;

FIG. 4 is an exploded perspective view of the ink container;

FIG. 5 is a perspective view of an ink pack provided in the ink container;

FIG. 6 is a perspective view of the cap in the ink pack;

FIG. 7 is a cross-sectional view of the cap;

FIG. 8 is a cross-sectional view of the cap; and

FIG. 9 is a cross-sectional view showing an attached state of the ink container to a container attachment unit.

### DETAILED DESCRIPTION

An ink container and an ink-jet recording apparatus according to an embodiment of the present disclosure are described below with reference to the drawings. The directional relationship is described below using the XYZ orthogonal coordinate axes. The X direction corresponds to the front and back direction (+X is back, and −X is front), the Y direction corresponds to the left and right direction (+Y is left, and −Y is right), and the Z direction is the up and down direction (+Z is up and −Z is down). Further, the term “sheet” used in the following description refers to copy paper, coat paper, OHP sheet, thick paper, postcard, tracing paper, or other sheet materials subjected to an image forming process, or sheet materials subjected to any process other than the image forming process.

### Overall Configuration of Ink-jet Recording Apparatus

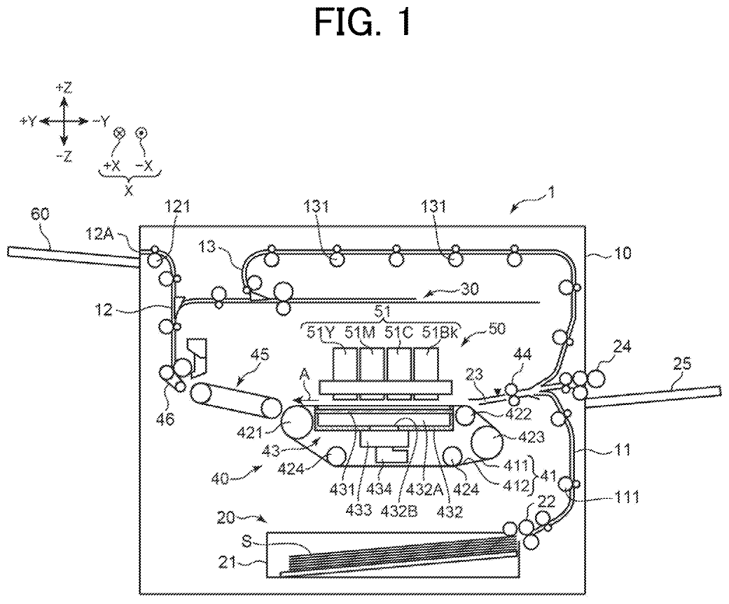

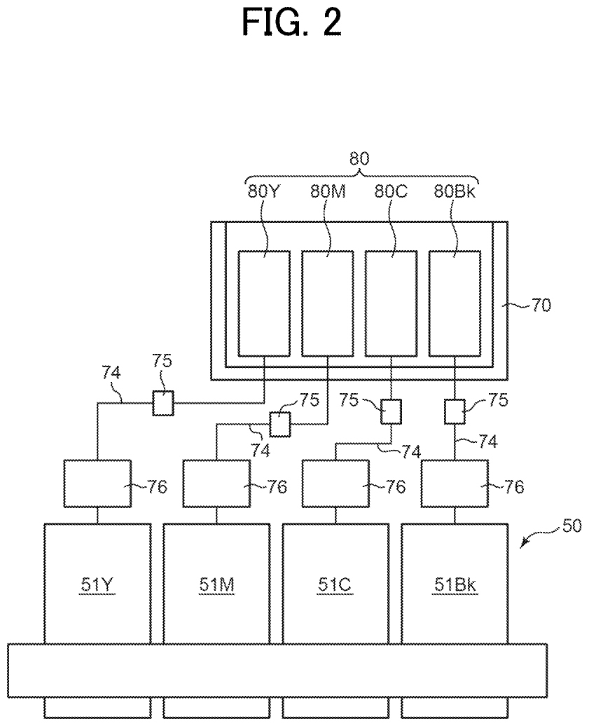

FIG. 1 is a view schematically showing an ink-jet recording apparatus 1 according to an embodiment of the present disclosure. FIG. 2 is an enlarged view of the periphery of a recording unit 50 of the ink-jet recording apparatus 1. The ink-jet recording apparatus 1 is an image forming apparatus that forms (records) an image on a sheet S by ejecting ink droplets. The ink-jet recording apparatus 1 includes an apparatus main body 10, a sheet feed unit 20, a sheet reversing unit 30, a sheet conveying unit 40, a recording unit 50, a sheet discharge unit 60, and an ink container 80.

The apparatus main body 10 is a box-shaped chassis that houses various apparatuses for recording images on the sheet S. A first conveyance path 11, a second conveyance path 12, and a third conveyance path 13, which are conveyance paths for the sheet S, are formed in the apparatus main body 10.

The sheet feed unit 20 feeds the sheet S to the first conveyance path 11. The sheet feed unit 20 includes a sheet feed cassette 21 and a pickup roller 22. The sheet feed cassette 21 is attachable to and detachable from the apparatus main body 10 and contains the sheet S therein. The pickup roller 22 is disposed at the end on the −Y side and the +Z side of the sheet feed cassette 21. The pickup roller 22 feeds the uppermost sheet S of the sheet bundle accommodated in the sheet feed cassette 21 one by one and sends it out to the first conveyance path 11.

The sheet S fed to the first conveyance path 11 is conveyed by a pair of first conveyance rollers 111 provided in the first conveyance path 11 to a pair of registration rollers 44 in the sheet conveying unit 40 disposed at the downstream end of the first conveyance path 11. Furthermore, a sheet feed tray 25 is disposed on the side surface on the −Y side of the apparatus main body 10, and the sheet S may be placed on the upper surface portion of the sheet feed tray 25. The sheet S placed on the sheet feed tray 25 is delivered by a sheet feed roller 24 toward the pair of registration rollers 44.

The pair of registration rollers 44 is a pair of conveyance rollers disposed at the upstream end in the sheet conveying unit 40. The pair of registration rollers 44 is rotated at a predetermined timing around the rotation axis extending in the sheet width direction (the X direction) orthogonal to the sheet conveying direction A so that it delivers the sheet S toward a conveyance belt 41 in the sheet conveying unit 40 through a sheet introduction guide section 23. The pair of registration rollers 44 performs skew correction on the sheet S and feeds the sheet S toward the conveyance belt 41 via the sheet introduction guide section 23 in accordance with the timing of image formation processing by the recording unit 50. In this manner, the pair of registration rollers 44 conveys the sheet S toward the recording unit 50. The sheet conveying direction A is a direction from the −Y side to the +Y side in the Y direction.

The sheet introduction guide section 23 guides the sheet S delivered by the pair of registration rollers 44 toward an outer circumferential surface 411 of the conveyance belt 41 in the sheet conveying unit 40.

When the leading end of the sheet S guided by the sheet introduction guide section 23 comes into contact with the outer circumferential surface 411 of the conveyance belt 41, it is conveyed in the sheet conveying direction A while being held on the outer circumferential surface 411 due to driving of the conveyance belt 41.

The sheet conveying unit 40 is disposed so as to be opposed to a line head 51 on the −Z side of the recording unit 50. The sheet conveying unit 40 conveys the sheet S guided and introduced by the sheet introduction guide section 23 in the sheet conveying direction A so that the sheet S passes through the −Z side of the recording unit 50. The sheet conveying unit 40 includes the conveyance belt 41 and a suction unit 43 in addition to the pair of registration rollers 44.

The conveyance belt 41 is an endless belt having a width in the Y direction and extending in the X direction. The conveyance belt 41 is disposed to be opposed to the recording unit 50 and conveys the sheet S in the sheet conveying direction A on the outer circumferential surface 411. More specifically, the conveyance belt 41 holds the sheet S on the outer circumferential surface 411 within a predetermined conveyance region opposed to the line head 51 of the recording unit 50 and conveys it in the sheet conveying direction A.

The conveyance belt 41 is stretched around a first roller 421, a second roller 422, a third roller 423, and a pair of fourth rollers 424. On the inner side of the stretched conveyance belt 41, the suction unit 43 is disposed so as to be opposed to an inner circumferential surface 412. The first roller 421 is a driving roller that extends along the Y direction that is the width direction of the conveyance belt 41 and is disposed on the downstream side of the suction unit 43 in the sheet conveying direction A. The first roller 421 is rotationally driven by a driving motor (not shown) and rotates the conveyance belt 41 in a predetermined circumferential direction. As the conveyance belt 41 revolves, the sheet S held on the outer circumferential surface 411 is conveyed in the sheet conveying direction A.

The second roller 422 is a belt-speed detection roller extending along the Y direction and is disposed on the upstream side of the suction unit 43 in the sheet conveying direction A. The second roller 422 is disposed to, in cooperation with the first roller 421, maintains the planarity of the region opposed to the line head 51 on the outer circumferential surface 411 of the conveyance belt 41 and the region opposed to the suction unit 43 on the inner circumferential surface 412 of the conveyance belt 41. Here, on the outer circumferential surface 411 of the conveyance belt 41, the region that is opposed to the line head 51 and between the first roller 421 and the second roller 422 is the predetermined conveyance region for holding and conveying the sheet S. The second roller 422 is driven to rotate in conjunction with the rotation of the conveyance belt 41. A pulse plate (not shown) is attached to the second roller 422, and the pulse plate is rotated integrally with the second roller 422. By measuring the rotation speed of the pulse plate, the rotation speed of the conveyance belt 41 is detected.

The third roller 423 is a tension roller extending along the Y direction and applies tension to the conveyance belt 41 to prevent the conveyance belt 41 from being loosened. The third roller 423 is driven to rotate in conjunction with the rotation of the conveyance belt 41. Each of the fourth rollers 424 in pair is a guide roller extending along the Y direction and guides the conveyance belt 41 so that the conveyance belt 41 passes the −Z side of the suction unit 43. The pair of fourth rollers 424 is driven to rotate in conjunction with the rotation of the conveyance belt 41.

Further, the conveyance belt 41 has a plurality of suction holes penetrating in the thickness direction from the outer circumferential surface 411 to the inner circumferential surface 412.

The suction unit 43 is disposed to be opposed to the recording unit 50 via the conveyance belt 41. More specifically, the suction unit 43 is disposed to be opposed to the inner circumferential surface 412 on the inner side of the conveyance belt 41 stretched by the first roller 421, the second roller 422, the third roller 423, and the pair of fourth rollers 424. The suction unit 43 causes the sheet S to be in close contact with the outer circumferential surface 411 of the conveyance belt 41 by generating a negative pressure between the sheet S held on the outer circumferential surface 411 of the conveyance belt 41 and the conveyance belt 41. The suction unit 43 includes a belt guide member 431, a suction chassis 432, a suction device 433, and an exhaust duct 434.

The belt guide member 431 is a plate-like member that is disposed to be opposed to the region between the first roller 421 and the second roller 422 on the inner circumferential surface 412 of the conveyance belt 41 and that has the width dimension that is substantially the same as the length of the conveyance belt 41 in the width direction (the Y direction). The belt guide member 431 forms the upper surface portion of the suction chassis 432 and has substantially the same shape as that of the suction chassis 432 when viewed from the +Z side. The belt guide member 431 guides the rotational movement of the conveyance belt 41 between the first roller 421 and the second roller 422 in conjunction with the rotation of the first roller 421.

Further, the belt guide member 431 has a plurality of groove portions formed on a belt guide surface opposed to the inner circumferential surface 412 of the conveyance belt 41. Each of the groove portions is formed corresponding to the suction hole of the conveyance belt 41. Further, the belt guide member 431 has through-holes provided corresponding to the respective groove portions. The through-hole is a hole penetrating in the thickness direction of the belt guide member 431 in each of the groove portions and communicating with the suction hole of the conveyance belt 41 via the groove portion.

The suction unit 43 having the above configuration and including the belt guide member 431 generates a suction force by suctioning air from the space on the +Z side of the conveyance belt 41 through the groove portion and the through-hole of the belt guide member 431 and the suction hole of the conveyance belt 41. By this suction force, an air flow (suction air) directed toward the suction unit 43 is generated in the space above the conveyance belt 41. When the sheet S is guided by the sheet introduction guide section 23 onto the conveyance belt 41 to cover part of the outer circumferential surface 411 of the conveyance belt 41, the suction force (negative pressure) acts on the sheet S so that the sheet S is tightly attached to the outer circumferential surface 411 of the conveyance belt 41.

In the suction unit 43, the suction chassis 432 is a box-shaped chassis having an opening on the +Z side and is disposed on the −Z side of the conveyance belt 41 so that the opening on the +Z side is covered with the belt guide member 431 forming the upper surface portion of the suction chassis 432. The suction chassis 432, in cooperation with the belt guide member 431 forming the upper surface portion thereof, defines a suction space 432A. That is, the space surrounded by the suction chassis 432 and the belt guide member 431 is the suction space 432A. The suction space 432A communicates with the suction hole of the conveyance belt 41 via the groove portion and the through-hole of the belt guide member 431.

An opening 432B is formed in the bottom wall portion of the suction chassis 432, and the suction device 433 is disposed corresponding to the opening 432B. An exhaust duct 434 is connected to the suction device 433. The exhaust duct 434 is connected to an exhaust port (not shown) provided in the apparatus main body 10.

On the +Z side of the sheet conveying unit 40, the recording unit 50 is disposed. Specifically, the recording unit 50 is disposed to be opposed to the outer circumferential surface 411 of the conveyance belt 41 on the +Z side of the sheet conveying unit 40. The recording unit 50 forms an image by applying an image forming process to the sheet S conveyed in the sheet conveying direction A while being held on the outer circumferential surface 411 of the conveyance belt 41. The recording unit 50 is of an ink-jet type as an image forming system and forms an image on the sheet S by ejecting ink droplets.

The recording unit 50 includes line heads 51Bk, 51C, 51M and 51Y. The line head 51Bk ejects black ink droplets, the line head 51C ejects cyan ink droplets, the line head 51M ejects magenta ink droplets, and the line head 51Y ejects yellow ink droplets. The line heads 51Bk, 51C, 51M and 51Y are arranged side by side from the upstream side to the downstream side in the sheet conveying direction A. The line heads 51Bk, 51C, 51M, and 51Y have the same structure except for the color of ink droplets to be ejected, so they are sometimes collectively referred to as line heads 51.

The line head 51 ejects ink droplets onto the sheet S conveyed in the sheet conveying direction A while being held on the outer circumferential surface 411 of the conveyance belt 41 to form an image on the sheet S. Specifically, the line head 51 ejects ink droplets toward the sheet S that is conveyed by the conveyance belt 41 and passes through the position opposed to the line head 51. Thus, an image is formed on the sheet S.

After ink droplets are ejected from the line head 51 and an image is formed on the sheet S, the sheet S is conveyed by the conveyance belt 41 and delivered to a conveying unit 45 disposed on the downstream side of the conveyance belt 41 in the sheet conveying direction A. The conveying unit 45 further conveys the sheet S received from the sheet conveying unit 40 to the downstream side in the sheet conveying direction A. A decurler unit 46 is provided on the downstream side of the conveying unit 45. The decurler unit 46 further conveys the sheet S to the downstream side in the sheet conveying direction A while correcting the curling of the sheet S received from the conveying unit 45. The sheet S conveyed by the decurler unit 46 is sent to the second conveyance path 12.

The second conveyance path 12 extends along the side surface on the +Y side of the apparatus main body 10. The sheet S delivered to the second conveyance path 12 is conveyed by a pair of second conveyance rollers 121 provided in the second conveyance path 12 toward a sheet discharge port 12A formed on the +Y side of the apparatus main body 10 and is discharged from the sheet discharge port 12A onto the sheet discharge unit 60.

Furthermore, when the sheet S delivered to the second conveyance path 12 is for duplex printing on which the image forming process has been completed for the first surface (the front surface), the sheet S is delivered to the sheet reversing unit 30. The sheet reversing unit 30 is a conveyance path branched in the middle of the second conveyance path 12 and is a part in which the sheet S is reversed (switched back). The sheet S turned over by the sheet reversing unit 30 is sent to the third conveyance path 13. The sheet S delivered to the third conveyance path 13 is fed back by a pair of third conveyance rollers 131 provided in the third conveyance path 13 and is fed to the outer circumferential surface 411 of the conveyance belt 41 again in a reversed state via the pair of registration rollers 44 and the sheet introduction guide section 23. The sheet S supplied onto the outer circumferential surface 411 of the conveyance belt 41 with its front and back surfaces turned over in this manner is conveyed by the conveyance belt 41 while the recording unit 50 performs an image forming process on the second surface (the back surface) that is opposite to the first surface. The sheet S on which duplex printing has been completed passes through the second conveyance path 12 and is discharged from the sheet discharge port 12A onto the sheet discharge unit 60.

### Configuration of Ink Container

In the apparatus main body 10, a container attachment unit 70 (FIG. 2) is provided above the +Z side of the recording unit 50. As shown in FIG. 2, ink containers 80Y, 80M, 80C, 80Bk each containing ink of each color, yellow (Y), magenta (M), cyan (C), or black (Bk), are detachably mounted in the container attachment unit 70. The ink containers 80Y, 80M, 80C, 80Bk are connected to the line heads 51Y, 51M, 51C, 51Bk, respectively, via ink supply tubes 74 and sub ink tanks 76 of the respective colors. Here, the ink containers 80Y, 80M, 80C, and 80Bk are sometimes collectively referred to as ink containers 80 because they have the same configuration except for the color of contained ink.

A solenoid valve 75 for opening and closing the ink flow path in the ink supply tube 74 is provided in a section of the ink supply tube 74 on the upstream side of the sub ink tank 76. An ink sensor (not shown) for detecting the amount of ink in the sub ink tank 76 is provided in the sub ink tank 76, and the solenoid valve 75 is opened in accordance with the amount of ink so that ink is supplied from the ink container 80 to the sub ink tank 76. The sub ink tank 76 is disposed at a lower position than the ink container 80, and the ink pressure generated due to a difference in height between the sub ink tank 76 and the ink container 80 causes the ink of the corresponding color to be supplied from the ink container 80 to the sub ink tank 76. Further, when the ink in the sub ink tank 76 becomes less than the predetermined amount in a state where the solenoid valve 75 is opened, it is determined that the ink in the ink pack 81 has run out.

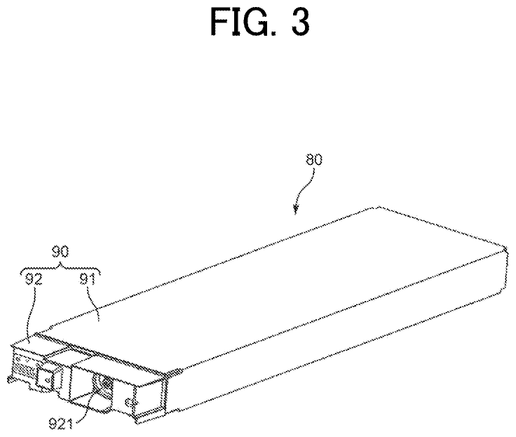

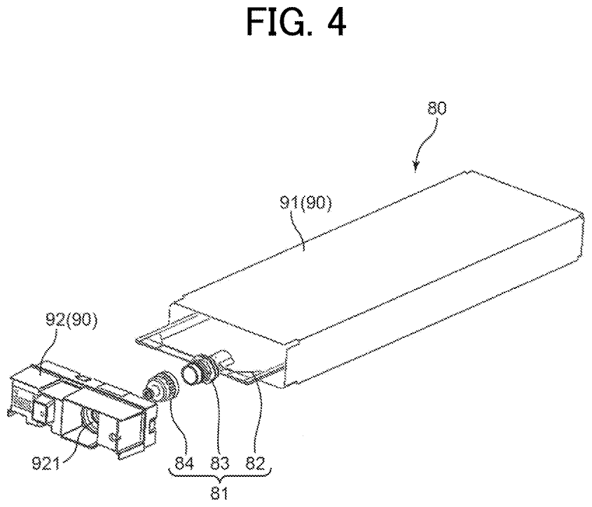

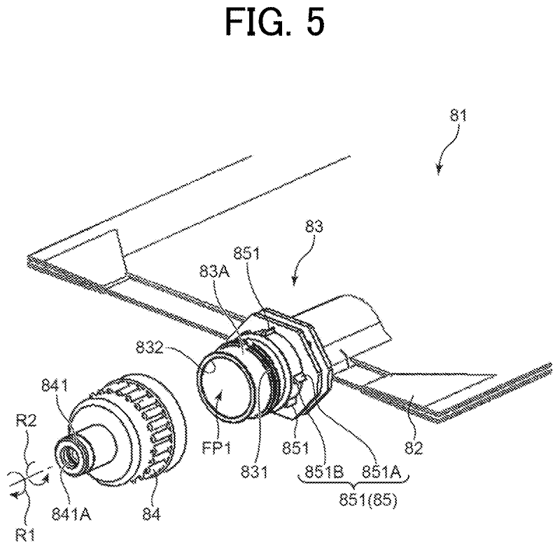

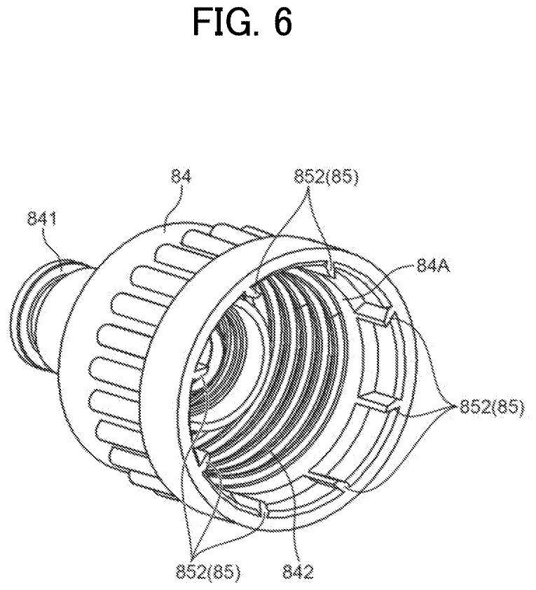

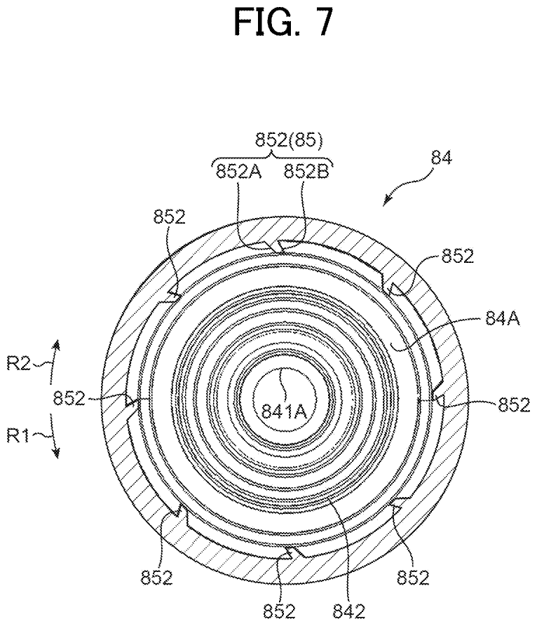

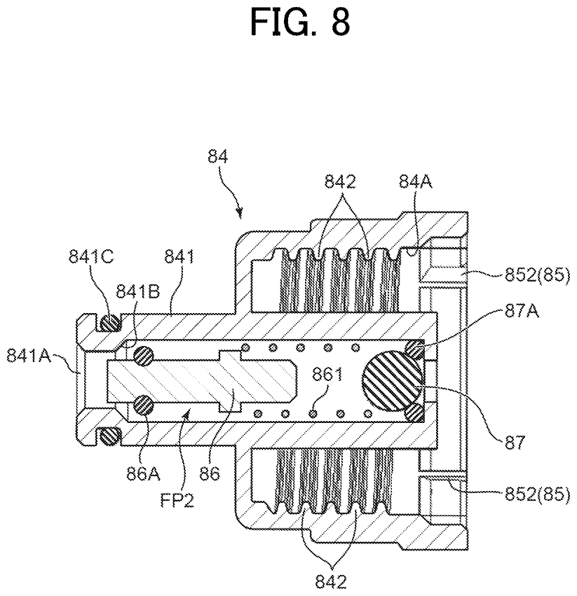

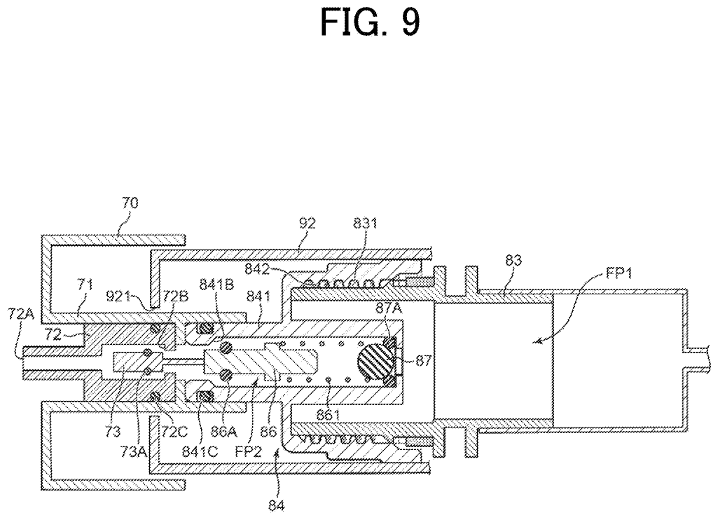

The configuration of the ink container 80 is described with reference to FIGS. 3 to 9 in addition to FIG. 2. FIG. 3 is a perspective view of the ink container 80, and FIG. 4 is an exploded perspective view of the ink container 80. FIG. 5 is a perspective view of the ink pack 81 provided in the ink container 80. FIG. 6 is a perspective view of a cap 84 of the ink pack 81, and FIGS. 7 and 8 are cross-sectional views of the cap 84. FIG. 9 is a cross-sectional view showing an attached state of the ink container 80 to the container attachment unit 70.

The ink container 80 includes an ink pack 81 that contains ink to be supplied to the line head 51 of the recording unit 50 and a housing case 90 that houses the ink pack 81 and is detachably attached to the container attachment unit 70.

As shown in FIGS. 3 and 4, the housing case 90 includes a case main body 91 and a case lid body 92. The case main body 91 forms a main body part for housing the ink pack 81 in the housing case 90. The case main body 91 is, for example, formed in a bottomed cylindrical shape having an opening at one end. The case lid body 92 is a lid body for sealing the opening of the case main body 91 in a state of housing the ink pack 81. The case lid body 92 is provided with an opening 921. In the ink pack 81 housed in the housing case 90, the end portion of the cap 84 described later is exposed from the opening 921 of the case lid body 92.

As shown in FIG. 5, the ink pack 81 includes a pack main body 82, a spout 83, the cap 84, and a rotation restricting mechanism 85. The pack main body 82 forms a main body part of the ink pack 81 to which the ink is supplied. The pack main body 82 is formed in a bag shape by a laminate film having flexibility.

The spout 83 is attached so as to be partially embedded at one end of the pack main body 82 (see FIG. 5). The spout 83 has a cylindrical shape and forms a first ink flow path FP1 communicating with the inside of the pack main body 82 (see FIGS. 5 and 9). The filling of ink into the pack main body 82 of the ink pack 81 and the supply of ink from the pack main body 82 to the line head 51 are performed via the first ink flow path FP1 of the spout 83 attached to the pack main body 82. The filling of ink into the pack main body 82 may be performed in a state where the first ink flow path FP1 of the spout 83 is opened, that is, in a state where an end opening 832 of the spout 83 is opened; therefore, the ink filling efficiency may be improved. Further, on an outer surface 83A of the spout 83, a male screw part 831 is formed.

The cap 84 is a lid body attached to the spout 83 so as to close the end opening 832 of the spout 83. The cap 84 is attached to the spout 83 after the pack main body 82 is filled with ink via the spout 83. As shown in FIGS. 6 to 8, a female screw part 842 is formed on an inner surface 84A of the cap 84. The female screw part 842 is engaged with the male screw part 831 of the spout 83 by rotation of the cap 84 relative to the spout 83 in a first rotation direction R1 (FIG. 5 and FIG. 7). The cap 84 is attached to the spout 83 due to the engagement between the female screw part 842 and the male screw part 831 by the rotation in the first rotation direction R1. In this way, in a state in which the cap 84 is attached to the spout 83 after filling the pack main body 82 with ink, the ink pack 81 is housed in the housing case 90. As described above, in the ink pack 81 housed in the housing case 90, the end part of the cap 84 is exposed from the opening 921 of the case lid body 92.

Further, the cap 84 includes a cylindrical flow-path forming part 841 including a protruding portion that protrudes outward from the end part. As shown in FIGS. 8 and 9, the flow-path forming part 841 forms therein a second ink flow path FP2 communicating with the first ink flow path FP1 of the spout 83 in a state where the cap 84 is attached to the spout 83. An on-off valve 86 and a check valve 87 are attached to the cap 84. More specifically, the on-off valve 86 and the check valve 87 are disposed inside the flow-path forming part 841, that is, in the second ink flow path FP2.

The on-off valve 86 is a valve that opens and closes the second ink flow path FP2. When the ink container 80 is attached to the container attachment unit 70, that is, when the housing case 90, in the state of housing the ink pack 81, is attached to the container attachment unit 70, the on-off valve 86 opens the second ink flow path FP2. On the other hand, when the ink container 80 is detached from the container attachment unit 70, that is, when the housing case 90, in the state of housing the ink pack 81, is detached from the container attachment unit 70, the second ink flow path FP2 is closed.

After filling the pack main body 82 with ink, the housing case 90 is attached to the container attachment unit 70 while the ink pack 81 with the cap 84 attached to the spout 83 is housed (see FIG. 9). When the housing case 90 is attached to the container attachment unit 70, the on-off valve 86 opens the second ink flow path FP2 formed in the flow-path forming part 841 of the cap 84. This allows the ink filled in the pack main body 82 to flow through the first ink flow path FP1 of the spout 83 and the second ink flow path FP2 of the cap 84 and to flow out of the flow path opening 841A at the end of the flow-path forming part 841. The ink flowing out of the flow path opening 841A is supplied to the line head 51. On the other hand, when the housing case 90 is detached from the container attachment unit 70, the on-off valve 86 closes the second ink flow path FP2 of the cap 84. Thus, when ink remains in the pack main body 82, the ink is prevented from leaking through the first ink flow path FP1 of the spout 83 and the second ink flow path FP2 of the cap 84.

The opening/closing action of the on-off valve 86 is described in detail with reference to FIG. 9. The on-off valve 86 is movable along the axial direction within the second ink flow path FP2 of the flow-path forming part 841. The on-off valve 86 moves within the second ink flow path FP2 to open and close the second ink flow path FP2. On the outer circumferential surface of the on-off valve 86, a seal member 86A is fixedly provided at the end on the side close to the container attachment unit 70. Further, a biasing force in the direction toward the container attachment unit 70 is applied to the on-off valve 86 by a biasing member 861 disposed in the second ink flow path FP2. The biasing member 861 is, for example, a compression coil spring.

The container attachment unit 70 to which the ink container 80 is attached includes: a cylindrical protrusion 71; a tubular ink supply flow-path forming part 72 disposed inside the protrusion 71 and connected to the above-described ink supply tube 74; and an attachment-unit side on-off valve 73 disposed in the ink supply flow-path forming part 72. The ink supply flow-path forming part 72 is fixed inside the protrusion 71. When the ink supply flow-path forming part 72 is fixedly disposed inside the protrusion 71, a seal member 72C fixedly provided on the outer circumferential surface of the ink supply flow-path forming part 72 abuts the inner surface of the protrusion 71. In this manner, ink is prevented from leaking from between the ink supply flow-path forming part 72 and the protrusion 71. The attachment-unit side on-off valve 73 is an on-off valve that opens and closes the inside of the ink supply flow-path forming part 72. The attachment-unit side on-off valve 73 opens the ink supply flow-path forming part 72 when the ink container 80 is attached to the container attachment unit 70. On the other hand, when the ink container 80 is detached from the container attachment unit 70, the ink supply flow-path forming part 72 is closed in order to prevent the outflow of ink from the ink supply flow-path forming part 72 and the contamination of foreign matter.

When the ink container 80 is attached to the container attachment unit 70, the flow-path forming part 841 of the cap 84 is inserted into the protrusion 71 that has entered the opening 921 of the case lid body 92. While the flow-path forming part 841 is inserted into the protrusion 71, a seal member 841C fixed to the outer circumferential surface of the flow-path forming part 841 is in contact with the inner surface of the protrusion 71. This prevents leakage of the ink from between the flow-path forming part 841 and the protrusion 71.

Further, when the flow-path forming part 841 is inserted into the protrusion 71, part of the attachment-unit side on-off valve 73 is inserted into the flow-path forming part 841 via the flow path opening 841A. Part of the attachment-unit side on-off valve 73 having entered the flow-path forming part 841 presses the on-off valve 86 in the flow-path forming part 841 toward the spout 83. At this time, the attachment-unit side on-off valve 73 moves such that the seal member 73A fixedly provided on the outer circumferential surface of the attachment-unit side on-off valve 73 separates from a seal contact surface 72B on the inner surface of the ink supply flow-path forming part 72. As a result, the attachment-unit side on-off valve 73 opens the ink supply flow-path forming part 72. Then, the on-off valve 86 disposed in the flow-path forming part 841 due to the pressing force of the attachment-unit side on-off valve 73 moves toward the spout 83 against the biasing force of the biasing member 861. When the on-off valve 86 moves toward the spout 83, the seal member 86A fixed to the outer circumferential surface of the on-off valve 86 separates from the seal contact surface 841B on the inner surface of the flow-path forming part 841. The above movement of the on-off valve 86 toward the spout 83 causes the on-off valve 86 to open the second ink flow path FP2 in the flow-path forming part 841.

Opening the second ink flow path FP2 by the on-off valve 86 allows the ink filled in the pack main body 82 to flow through the first ink flow path FP1 of the spout 83 and the second ink flow path FP2 of the cap 84 and to flow out of the flow path opening 841A at the end of the flow-path forming part 841. After flowing out of the flow path opening 841A, the ink flows through the ink supply flow-path forming part 72 where the attachment-unit side on-off valve 73 is opened. After having passed through the ink supply flow-path forming part 72, the ink is supplied to the line head 51 via the ink supply tube 74 connected to the supply opening 72A of the ink supply flow-path forming part 72.

On the other hand, separation of the ink container 80 from the container attachment unit 70 cancels the pressing force by the attachment-unit side on-off valve 73 toward the spout 83 against the on-off valve 86 disposed in the flow-path forming part 841. This causes the on-off valve 86 to move in the direction opposite to the side of the spout 83 due to the biasing force of the biasing member 861. This movement of the on-off valve 86 causes the seal member 86A fixed to the outer circumferential surface of the on-off valve 86 to be in contact with the seal contact surface 841B on the inner surface of the flow-path forming part 841. Then, the second ink flow path FP2 in the flow-path forming part 841 is closed. Furthermore, when the ink container 80 is detached from the container attachment unit 70, the attachment-unit side on-off valve 73 moves such that the seal member 73A fixed to the outer circumferential surface of the attachment-unit side on-off valve 73 is brought into contact with the seal contact surface 72B on the inner surface of the ink supply flow-path forming part 72. Thus, the attachment-unit side on-off valve 73 closes the ink supply flow-path forming part 72.

As shown in FIGS. 8 and 9, the check valve 87 disposed inside the flow-path forming part 841 is a valve that prevents back-flow of the ink in the second ink flow path FP2 into the pack main body 82 via the first ink flow path FP1. In the example shown in FIGS. 8 and 9, the check valve 87 is a ball-type check valve. While the ink container 80 is attached to the container attachment unit 70 and the on-off valve 86 opens the second ink flow path FP2 of the cap 84, the check valve 87 is in contact with the seal member 87A fixed to the inner surface of the flow-path forming part 841 unless the pump for feeding ink to the line head 51 is not in operation. While the check valve 87 is in contact with the seal member 87A, the communication between the second ink flow path FP2 of the cap 84 and the first ink flow path FP1 of the spout 83 is blocked. This prevents back-flow of ink into the pack main body 82 via the first ink flow path FP1. On the other hand, when the pump for supplying ink to the line head 51 is in operation, the check valve 87 is separated from the seal member 87A. This enables the communication between the second ink flow path FP2 of the cap 84 and the first ink flow path FP1 of the spout 83 and enables supply of ink to the line head 51.

Next, the rotation restricting mechanism 85 provided in the ink pack 81 is described with reference to FIGS. 5 to 7. The rotation restricting mechanism 85 is a mechanism that restricts the rotation of the cap 84 relative to the spout 83 in a second rotation direction R2, which is opposite to the first rotation direction R1 during attachment, in a state where the female screw part 842 formed on the inner surface 84A of the cap 84 is engaged with the male screw part 831 formed on the outer surface 83A of the spout 83 so that the cap 84 is attached to the spout 83. This prevents the cap 84 from being loosened from the spout 83 due to the effect of vibrations, or the like, during transportation of the ink container 80 and prevents the cap 84 from being improperly removed from the spout 83. Thus, while the cap 84 is attached to the spout 83, a reduction in the sealing force of the cap 84 against the spout 83 may be suppressed as much as possible, and thus, it is possible to prevent leakage of the ink through the first ink flow path FP1 of the spout 83.

Specifically, the rotation restricting mechanism 85 includes: a plurality of first projecting pieces 851 (FIG. 5) projecting from the outer surface 83A of the spout 83; and a plurality of second projecting pieces 852 (FIGS. 6 and 7) projecting from the inner surface 84A of the cap 84. The first projecting pieces 851 are arranged at a predetermined interval in the circumferential direction on the outer surface 83A of the spout 83. Likewise, the second projecting pieces 852 are arranged at a predetermined interval in the circumferential direction on the inner surface 84A of the cap 84. While the cap 84 is attached to the spout 83, each of the first projecting pieces 851 is engaged with the corresponding one of the second projecting pieces 852. Thus, rotation of the cap 84 relative to the spout 83 in the second rotation direction R2 is restricted while the cap 84 is attached to the spout 83.

Each of the first projecting pieces 851 provided on the spout 83 includes: a first rotation allowing surface 851A on the upstream side in the first rotation direction R1 during attachment of the cap 84; and a first rotation restricting surface 851B on the downstream side. The first rotation allowing surface 851A and the first rotation restricting surface 851B are inclined surfaces. Each of the second projecting pieces 852 provided on the cap 84 includes: a second rotation allowing surface 852A on the downstream side in the first rotation direction R1; and a second rotation restricting surface 852B on the upstream side. The second rotation allowing surface 852A and the second rotation restricting surface 852B are inclined surfaces.

When the cap 84 is rotated relative to the spout 83 in the first rotation direction R1, attachment of the cap 84 with the spout 83 proceeds while each of the second projecting pieces 852 is elastically deformed due to the surface contact of the second rotation allowing surface 852A with the first rotation allowing surface 851A.

After the female screw part 842 is engaged with the male screw part 831 by rotation of the cap 84 relative to the spout 83 in the first rotation direction R1 so that the cap 84 is completely attached to the spout 83, the second rotation restricting surface 852B is in surface contact with the first rotation restricting surface 851B, and each of the first projecting pieces 851 is engaged with the corresponding one of the second projecting pieces 852. In this way, while the second rotation restricting surface 852B is in surface contact with the first rotation restricting surface 851B, elastic deformation of each of the second projecting pieces 852 is restricted even when the force for rotation in the second rotation direction R2 is applied to the cap 84, whereby the rotation of the cap 84 in the second rotation direction R2 is prevented. Thus, rotation of the cap 84 relative to the spout 83 in the second rotation direction R2 is restricted while the cap 84 is attached to the spout 83. Thus, it is possible to prevent the cap 84 from being loosened from the spout 83 and prevent the cap 84 from being improperly removed from the spout 83 due to the effect of vibrations, or the like, during transportation of the ink container 80.

What is claimed is:

1. An ink container in an ink-jet recording apparatus including a recording unit that records an image on a sheet by using ink, the ink container being attachable to an apparatus main body in which the recording unit is disposed, the ink container comprising:
an ink pack containing the ink to be supplied to the recording unit; and
a housing case that houses the ink pack and is detachably attached to the apparatus main body, wherein
the ink pack includes:
a pack main body filled with the ink;
a tubular spout that is attached to an end of the pack main body, forms a first ink flow path communicating with inside of the pack main body, and includes a male screw part on an outer surface thereof;
a cap having, on an inner surface thereof, a female screw part to be engaged with the male screw part by rotation of the cap relative to the spout in a first rotation direction; and
a rotation restricting mechanism that restricts rotation of the cap relative to the spout in a second rotation direction opposite to the first rotation direction in a state where the female screw part is engaged with the male screw part and the cap is attached to the spout.

2. The ink container according to claim 1, wherein
the rotation restricting mechanism includes:
a first projecting piece that projects from the outer surface of the spout; and
a second projecting piece that projects from the inner surface of the cap and is engaged with the first projecting piece.

3. The ink container according to claim 1, wherein
the cap has a second ink flow path communicating with the first ink flow path in a state where the cap is attached to the spout, and
the ink pack further includes an on-off valve for opening and closing the second ink flow path.

4. The ink container according to claim 3, wherein
the on-off valve is attached to the cap.

5. The ink container according to claim 3, wherein
the on-off valve is configured to open the second ink flow path when the housing case in a state of housing the ink pack is attached to the apparatus main body and configured to close the second ink flow path when the housing case is detached from the apparatus main body.

6. The ink container according to claim 3, wherein
a check valve for preventing back-flow of the ink in the second ink flow path into the pack main body via the first ink flow path is attached to the cap.

7. An ink-jet recording apparatus comprising:
an apparatus main body in which a recording unit for recording an image on a sheet by using ink is disposed; and
the ink container according to claim 1, detachably attached to the apparatus main body and containing the ink to be supplied to the recording unit.
